(19) United States
(12) Patent Application Publication
(10) Pub. No.: US 2018/0195339 A1
(43) Pub. Date: Jul. 12, 2018

(54) CONNECTOR FOR CONNECTING TWO HOLLOW PROFILES, COMPRISING A MEMBRANE

(71) Applicant: SAINT-GOBAIN GLASS FRANCE, Courbevoie (FR)

(72) Inventors: Hans-Werner KUSTER, AACHEN (DE); Walter SCHREIBER, AACHEN (DE); Karl-Theo ROES, DUESSELDORF (DE); Erol Ertugrul SACU, STOLBERG (DE); Jan HIERSEMENZEL, KREUZLINGEN (CH)

(21) Appl. No.: 15/740,344

(22) PCT Filed: Oct. 13, 2016
(86) PCT No.: PCT/EP2016/074546

§ 371 Date: Mar. 30, 2018

(30) Foreign Application Priority Data
Oct. 13, 2015 (EP) 15189557.0

(51) Int. Cl. E06B 3/667; E06B 3/677

(52) U.S. Cl. CPC E06B 3/6675; E06B 3/677

(57) ABSTRACT

A connector for connecting two hollow-profile strips of an insulating glazing unit is presented. The connector includes two plug-in legs suitable for insertion into the hollow-profile strips, and a connection region where the two plug-in legs are connected. The connection region includes an outer surface, two pane contact surfaces, and an inner surface. According to one aspect, the connector includes a cavity to establish a passage from the inner interpane space to corresponding surroundings of the insulating glazing unit. According to another aspect, the cavity has a first opening in the outer surface of the connection region that is sealed with a gas-permeable and water-vapor-tight membrane.

The invention relates to a connector for connecting two hollow-profile strips, an insulating glazing unit, a method for production thereof, and use thereof.

Insulating glazing units usually contain at least two panes made of glass or polymeric materials. The panes are separated from one another via a gas or vacuum space defined by the spacer. The thermal insulation capacity of insulating glass is significantly greater than that of single-pane glass and can be even further increased and improved in triple glazing units or with special coatings. Thus, for example, silver-containing coatings enable reduced transmittance of infrared radiation and thus reduce the cooling of a building in the winter.

In addition to the nature and the structure of the glass, the other components of an insulating glazing unit are also of great significance. The seal and especially the spacer have a great influence on the quality of the insulating glazing unit. Especially the contact points between the spacer and the glass pane are very susceptible to temperature and climate fluctuations. The connection between pane and spacer is produced via an adhesive bond of an organic polymer, for example, polyisobutylene. Besides the direct effects on the physical properties of the adhesive bond, the glass itself in particular has an impact on the adhesive bond. Due to the changes in temperature, for example, from sunlight, the glass expands or contracts again upon cooling. At the same time, this mechanical movement expands or compresses the adhesive bond, which can compensate these movements only to a limited extent through its own elasticity. During the course of the service life of the insulating glazing unit, the mechanical stress described can cause a partial or complete areal detachment of the adhesive bond. This detachment of the adhesive bond can subsequently enable penetration of atmospheric moisture inside the insulating glazing unit. These climatic loads can lead to condensation in the region of the panes and a decrease in the insulating effect.

The interpane spaces are tightly sealed to reduce the atmospheric moisture in the interpane space to a minimum. This is necessary to prevent the development of condensation since moisture could result, in particular, in oxidation of vapor-deposited metal-containing coatings on the panes. Due to the leak-tight design of the interpane space, pressure equalization with the surroundings is, however, not possible. With a change in ambient conditions, such as pressure and temperature, the pressure difference between the surroundings and the inner interpane space results in inward or outward bulging of the glass panes. Among other things, this has as a consequence an increased loading of the edge seal. Moreover, jamming of built-in movable components, such as blinds, can occur due to inward bulging of the panes. To reduce these problems, a passage can be established from the inner interpane space to the surroundings, which enables pressure equalization. The passage must be implemented such that penetration of water vapor into the interpane space is prevented and, at the same time, penetration of dirt and dust is precluded.

CH 687 937 A5 discloses an insulating glazing unit with a desiccant-filled hollow-profile spacer frame, which has nonperforated sections and sections perforated into the interpane space. A capillary tube that opens into a nonperforated section of the spacer frame is provided for pressure equalization between the pane interior and the external surroundings. The actual capillary tube is arranged in the outer interpane space and is surrounded there by a secondary sealant. An opening of the capillary tube points toward the external surroundings. A disadvantage of this solution is the complicated production of the finished insulating glazing unit since the capillary is very delicate.

DE 10 2005 002 285 A1 discloses a complicated insulated glazing pressure equalization system with a capillary and a membrane, provided for use in the interpane space of thermal insulating glazings. The pressure equalization system can also be integrated into an enlarged spacer. Disadvantageous, here again, is the complicated integration of the pressure equalization system that is fastened in cavities of the spacer via stainless steel clamps.

The object of the invention is to provide a connector for connecting two hollow-profile strips that enables simple production of an insulating glazing unit with pressure equalization, also to provide an improved insulating glazing unit and an improved method for producing such an insulating glazing unit.

The object of the present invention is accomplished by a connector in accordance with independent claim 1. Preferred embodiments are apparent from the subclaims.

An insulating glazing unit according to the invention, a method for producing the insulating glazing unit according to the invention, and use thereof according to the invention are apparent from additional independent claims.

The connector according to the invention is suitable for connecting two hollow-profile strips in insulating glazing units. These hollow-profile strips are used as spacers in insulating glazing units. The connector comprises at least two plug-in legs and a connection region that connects the two plug-in legs to one another. The two plug-in legs are suitable for being inserted in each case into a hollow-profile strip and thus for establishing a connection between two hollow-profile strips. The connection region connects the two plug-in legs to one another and is not intended to be inserted into a hollow-profile strip. The connection region comprises an outer surface, an inner surface, and a pane contact surface. The outer surface points, in the finished insulating glazing unit, toward the surroundings; the inner surface points, in the finished insulating glazing unit, toward the inner interpane space; and the pane contact surfaces are provided such that the outer panes of the insulating glazing unit can be installed there by a suitable sealant. A cavity that is suitable for establishing, in an insulating glazing unit, a passage from the inner interpane space to the surroundings is provided in the connector according to the invention. The cavity has a first opening in the outer surface of the connection region. This opening is closed with a gas-permeable and water-vapor-tight membrane. The membrane prevents the penetration of moisture and dust from the surroundings. The cavity closed with a membrane serves to establish, in the finished insulating glazing unit, pressure equalization between the atmosphere and the inner interpane space of an insulating glazing unit. The connector according to the invention with integrated capability for pressure equalization is installed during the assembly of the spacer frame. Thus, the pressure equalization element no longer has to be installed in a separate step. The connector connects two hollow-profile strips that are assembled to form a spacer frame. The two plug-in legs are located in the hollow space of the hollow-profile strips and are completely hidden. The connector according to the invention thus provides a simple capability for integrating pressure equalization into an insulating glazing unit with hollow-profile spacers.

A spacer frame can be formed by one hollow-profile strip that is bent to form a frame, and whose two ends are connected by a connector according to the invention. A spacer frame can also be assembled from a hollow-profile strip broken into a plurality of strips, wherein two individual strips are connected by a connector according to the invention and the remaining strips are connected using prior art corner connectors.

The gas-permeable and water-vapor-tight membrane preferably contains a polypropylene, a polyamide, a polytetrafluoroethylene (PTFE), a polyester, a polymer from the group of perfluoralkoxy polymers (PFA) and/or copolymers thereof. Particularly preferably, the membrane contains a polytetrafluoroethylene (PTFE). With this, particularly good values for moisture diffusion density are obtained. Most particularly preferably, the membrane contains or is made of an expanded microporous PTFE. These membranes are are very well suited for use as a pressure equalization membrane and achieve optimal low values for water vapor permeability with, at the same time, good processability.

Preferably, the MVTR (moisture vapor transmission rate) value of the gas-permeable and water-vapor-tight membrane is between 0.001 g/(m² d) and 0.005 g/(m² d) [grams per square meter per day]. The MVTR value is a measure indicating the permeability of water vapor through the semipermeable membrane. It describes the amount of water in grams that diffuses through a square meter of material in 24 hours.

The thickness of the membrane is preferably in the range from 1 to 100 μm. The pore size of the semipermeable membrane is preferably in the range from 0.01 μm to 10 μm.

Preferably, the semipermeable membrane is arranged, for example, laminated, on a carrier material. This can be a woven fabric or knitted textile.

The connector according to the invention ist preferably a corner connector or a longitudinal connector. The two plug-in legs form an angle α, where 45°<α≤180°. In the case of a corner connector, the angle is preferably 90°; and in the case of a longitudinal connector, 180°. These embodiments are particularly stable and suitable for producing conventional rectangular insulating glass windows.

In a preferred embodiment of the connector according to the invention, the cavity has a second opening in the inner surface of the connection region . The cavity thus connects, in the finished insulating glazing unit, the inner interpane space with the surroundings. The pressure equalization is thus done directly between the surroundings and the inner interpane space, which it is particularly effective and simple to implement. The membrane over the first opening of the cavity prevents moisture from entering into the inner interpane space.

In another preferred embodiment of the connector according to the invention, the cavity has a second opening in an end face of one of the two plug-in legs. The cavity runs from the connection region inside one of the two plug-in legs all the way to the second opening in the end face of the plug-in leg. In the finished insulating glazing unit, the cavity is thus open to the hollow space of the hollow-profile strip. Since the hollow-profile strip is usually gas-permeable toward the inner interpane space, pressure equalization between the surroundings and the inner interpane space is thus enabled in the finished insulating glazing unit. The air flowing in through the membrane arrives first in the hollow space of the hollow-profile strip, which can be filled with a desiccant. In this case, any moisture present is removed from the air flowing in by the desiccant before it arrives in the inner interpane space. This results in improved protection against moisture in the inner interpane space. Since the cavity has only a first and a second opening, the airflow in the spacer frame can be selectively guided into a section of the hollow-profile strip.

In another preferred embodiment, the cavity is arranged along both plug-in legs, and the second opening and a third opening are arranged in the end faces of the two plug-in legs. The cavity branches in the connection region and runs then inside the two plug-in legs to two openings in their end faces. Accordingly, the cavity is, in the finished insulating glazing unit, open to the hollow space of two hollow-profile strips. The air flowing in through the first opening can flow in two directions. Thus, particularly effective pressure equalization can be achieved.

The end face of a plug-in leg is the surface, which points, on insertion of the connector into a hollow-profile strip, toward its hollow space. Thus, the end face does not rest directly against an inner side of the hollow-profile strip. After connection of the plug-in leg to a hollow-profile strip, the pane contact surfaces of the connection region and the outer surface of the connection region are exposed. The pane contact surfaces are the surfaces, which point, in the finished insulating glazing unit, toward the outer panes and are arranged parallel to the outer panes of the insulating glazing unit. The pane contact surfaces can also be connected to the outer panes. The outer surface is the surface, which points, in the finished insulating glazing unit, to the surroundings or is at least partially in contact with the secondary sealant.

In a preferred embodiment of the corner connector according to the invention, the connection region protrudes forward relative to the plug-in legs. The distance of protrusion U of the outer surface of the connection region beyond the outer sides of the plug-in legs is 1 mm to 10 mm, preferably 2 mm to 5 mm, and particularly preferably 3 mm to 4 mm. By means of the enlargement of the connection region, the stability of the connector is increased. In the finished insulating glazing unit, it is thus possible for the material of the secondary sealant to end flush with the outer surface of the connection region. This results in a very stable arrangement and contamination of the membrane with a secondary sealant is prevented. The connection region also preferably protrudes somewhat relative to the side faces of the plug-in legs. The size of this protrusion distance depends on the hollow-profile strip to be used. Preferably, the hollow-profile strip ends, in the insulating glazing unit, flush with the pane contact surfaces of the connection region.

Preferably, in an enlarged connection region, the membrane is mounted in a recess in the connection region (see figures). This protects the membrane against damage, which can occur, for example, during the assembly of the insulating glazing unit.

In a preferred embodiment of the connector according to the invention, at least the outer surface of the connection region is provided with a water-vapor-tight barrier. This barrier is preferably a metal layer that is applied directly on the outer surface of the connection region. This metallization contains aluminum, aluminum oxides, and/or silicon oxides and is preferably applied via a PVD method (physical vapor deposition). The coating containing aluminum, aluminum oxides, and/or silicon oxides delivers particularly good results in terms of leak-tightness. Alternatively, a film coated with metal can also be used. In particular, in the case of connectors made of polymeric materials that have high permeability to water vapor, such an additional barrier is advantageous for improving the leak-tightness of the edge seal.

The connector is preferably implemented rigid. This means that after the production of the connector with an integrated cavity with the membrane, it is no longer bendable in the connection region. The angle a between the two plug-in legs can then no longer be changed substantially, in other words, can be changed by at most 5°, preferably by at most 1°. This design improves the stability of the connector and prevents damage to the attachment of the membrane in the connection region.

In a preferred embodiment of the connector according to the invention, the connector is produced in an injection molding process. The plug-in legs and the connection region are injection molded. The membrane is preferably directly integrated during the injection molding process such that a separate step for attaching the membrane is no longer needed. A possible method for producing a connector according to the invention includes, first, providing a membrane that is inserted into an injection mold in which the plug-in legs and the connection region are then molded. After the curing of the material, the finished connector can be removed from the injection mold.

In another preferred embodiment of the connector according to the invention, the membrane is arranged in a sleeve. The sleeve is attached in the first opening of the cavity via a seal. The seal ensures that inflowing air can arrive in the interpane space only through the membrane. Sleeves with different membranes/valves can be used for pressure equalization. The advantage of this design is that the membrane can easily be varied. The seal preferably contains a polyisobutylene. The polyisobutylene can be a cross-linking or a non-cross-linking polyisobutylene.

In another preferred embodiment of the connector according to the invention, the membrane in the first opening of the cavity is covered, for example, by a rubber cap. The cover serves to protect the membrane against the penetration of dirt or of a secondary sealant that is used during the sealing of the insulating glazing unit.

Preferably, the connector is made polymers since these have low thermal conductivity, which results in improved thermal insulation properties of the edge seal. Particularly preferably, the connector contains biocomposites, polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), polyvinyl chloride (PVC), particularly preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

In a possible embodiment, the polymeric connector is fiber-reinforced. The connector preferably has a fiber content of 5% to 60%, particularly preferably of 20% to 50%. The fiber content in the connector according to the invention improves strength and stability. Through the selection of the fiber content, the coefficient of thermal expansion of the connector can be varied and adapted to the hollow-profile spacer. Preferably, natural fibers or glass fibers, particularly preferably glass fibers, are used for reinforcing the connector.

In an alternative embodiment, the connector can also be made of metal.

The connector according to the invention can be implemented both as a single and as a multiple connector. A single connector includes two plug-in legs to accommodate, in each case a hollow-profile strip. A multiple connector has, in contrast, at least four plug-in legs, half of which run parallel to one another in each case. In the connection region, the multiple connector has a web from which all legs of the connector emanate. In a preferred embodiment, the connector according to the invention is implemented as a double corner connector. It has four plug-in legs, of which two, respectively, are arranged parallel to one another. Such a double corner connector preferably includes one or a plurality of cavities that are closed with a gas-permeable and water-vapor-tight membrane.

The invention further includes an insulating glazing unit having a connector with an integrated membrane, in particular a connector according to the invention. The insulating glazing unit according to the invention comprises at least one first pane, a second pane arranged parallel thereto, and a peripheral spacer frame arranged between the first pane and the second pane. The spacer frame comprises at least one hollow-profile strip and at least one connector. The first pane, the second pane, and the spacer frame delimit an inner interpane space. The connector comprises at least two plug-in legs and a connection region. The two plug-in legs are connected to one another in the connection region. The two plug-in legs are inserted into the ends of the at least one hollow-profile strip and connect it to form a peripheral spacer frame. The connection region is situated outside the hollow-profile strip, while the plug-in legs are situated inside the hollow space of the hollow-profile strip. The connection region comprises an outer surface pointing toward the surroundings, two pane contact surfaces pointing toward the two panes, and an inner surface pointing toward the inner interpane space. The pane contact surfaces preferably run parallel to the panes. A cavity that establishes a passage from the inner interpane space to the surroundings and thus enables pressure equalization is provided in the connector connector. The cavity has a first opening in the outer surface of the connection region. The first opening is closed with a gas-permeable and water-vapor-tight membrane. In this manner, pressure equalization at the time of changes in ambient conditions is ensured in the insulating glazing unit according to the invention with a membrane arranged in the connector. The pressure equalization element is installed in the insulating glazing unit according to the invention via the connector. Leaks that can occur with a subsequent introduction of a pressure equalization element into the spacer frame via a cavity are thus avoided.

In a preferred embodiment of the insulating glazing unit according to the invention, the cavity has a second opening in the inner surface of the connection region . The cavity is open toward the inner interpane space via the second opening and open toward the surroundings via the first opening. The cavity thus establishes a direct passage from the inner interpane space to the surroundings and enables particularly effective pressure equalization. The water-vapor-tight membrane prevents penetration of moisture and dust into the inner interpane space.

The spacer frame can comprise a plurality of individual hollow-profile strips, which are combined to form a complete frame. The individual strips can be welded together, glued together, or plugged together via connectors. The hollow-profile strip can also be produced continuous and bent in the corners. The ends of the hollow-profile strip are connected at at least one point via a connector according to the invention. Preferably, the spacer frame is implemented rectangular. Most insulating glazing units are made in this shape.

The spacer frame is preferably attached between the first pane and the second pane via a primary sealant. Thus, good sealing of the inner interpane space against the external surroundings is obtained. The penetration of moisture and the loss of a gas filling that is possibly present are thus prevented. The primary sealant preferably contains a polyisobutylene. The polyisobutylene can be a cross-linking or a non-cross-linking polyisobutylene.

A known hollow-profile spacer strip according to the prior art can be used as the hollow-profile strip regardless of its material composition. Polymeric or metallic hollow-profile strips are mentioned here by way of example.

In a preferred embodiment of the insulating glazing unit according to the invention, the hollow-profile strip comprises at least a first side wall, a second side wall arranged parallel thereto, a glazing interior wall arranged perpendicular to the side walls, and an outer wall. The glazing interior wall connects the side walls to one another. The outer wall is arranged substantially parallel to the glazing interior wall and connects the side walls to one another. The first side wall, the glazing interior wall, the second side wall, and the outer wall enclose a hollow space. The hollow space improves the thermal conductivity of the hollow-profile strip compared to a solid profile strip and can, for example, accommodate a desiccant. The glazing interior wall includes at least one permeable section such that a possibility for a gas exchange between the hollow space and an inner interpane space is present. The exchange of gases and moisture between the inner interpane space and the hollow space is possible in the permeable section. The hollow space contains, at least in the permeable section, a desiccant, which absorbs moisture possibly present in the inner interpane space and thus prevents fogging of the panes. The permeability of the glazing interior wall can be achieved through the use of a porous material and/or through at least one perforation in the glazing interior wall.

In another preferred embodiment of the insulating glazing unit according to the invention, the cavity has a second opening in an end face of one of the two plug-in legs. The cavity runs from the first opening in the connection region inside one of the two plug-in legs all the way to the second opening in the end face of the plug-in leg. The cavity is thus open to the hollow space of the hollow-profile strip. The second opening is arranged in a section of the hollow-profile strip, whose hollow space is connected to the permeable section or which is itself a permeable section. In the permeable section, the glazing interior wall of the hollow-profile strip is implemented permeable. It is important for the second opening of the connector to open into a section of the hollow-profile strip that is connected to a permeable section of the hollow profile such that pressure equalization between the surroundings and the inner interpane space is possible. The air flowing in through the membrane arrives first in the hollow space of the hollow-profile strip, which is at least partially filled with a desiccant. Moisture possibly present is removed from the inflowing air by the desiccant before it arrives in the inner interpane space. This results in improved protection against moisture in the inner interpane space. Since the cavity has only a first and a second opening, the flow of air in the spacer frame can be selectively guided into one section of the hollow-profile strip.

In a particularly preferred embodiment of the insulating glazing unit according to the invention, the second opening of the connector is arranged in a section of the hollow-profile strip with an impermeable glazing interior wall, and the impermeable section is connected to a permeable section. In this context, “impermeable” means gas-impermeable and moisture-impermeable. This can be achieved through the selection of the material of the glazing interior wall or through the application of a barrier film, as is also used for the outer wall of hollow-profile spacers. Preferably, a desiccant is arranged in the impermeable section. The inflowing air is thus first dried in the impermeable section filled with desiccant and only after that flows via the permeable region into the inner interpane space. This results in further improved protection against moisture in the inner interpane space.

Preferably, the gas flow in the spacer frame or in the hollow-profile strip is interrupted by the connector. The connector is preferably implemented such that no gas exchange is possible through the connector between the connected ends of the hollow-profile strip. Alternatively, a partition can be introduced into the hollow-profile or a gas-impermeable rubber stopper can be installed downstream from the connector. The interruption of the gas flow ensures that the ambient air flowing in through the membrane flows in only one direction and, thus, always first through the same sections filled with desiccant. Thus, the efficiency of the drying can be further increased. Preferably, all sections of the hollow-profile strip are filled with a desiccant such that effective drying of the inflowing ambient air and of the inner interpane space are ensured.

The length d of the impermeable section, measured along the peripheral spacer frame is preferably at least 0.2 A, where A is the perimeter of the spacer frame along the glazing interior wall. Preferably, d≥0.3 A, particularly preferably d≥0.5 A. Thus, the drying path of the stream of air in the gas-impermeable region is increased such that long-term stability, insulating action, and service life of the glazing unit are further optimized.

Preferably, the glazing interior wall includes perforations. The total number of perforations depends on the size of the insulating glazing unit. The perforations are preferably implemented as slots, particularly preferably as slots with a width of 0.2 mm and a length of 2 mm. The slots ensure an optimum exchange of air without the desiccant being able to penetrate out of the hollow space into the inner interpane space. Through the provision of a certain number of perforations, the permeability of the glazing interior wall can be adapted, in a simple manner, to the given conditions and can be varied in different regions of the hollow-profile strip.

The first side wall and the second side wall of the hollow-profile strip are provided for the first pane and the second pane to be attached there. Preferably, the first pane and the second pane are attached to the first side wall or to the second side wall via a primary sealant. The inner interpane space is delimited by the first pane, the second pane, and the glazing interior wall of the hollow-profile strip. The outer wall of the hollow-profile strip and the first and second pane delimit an outer interpane space. The outer interpane space is preferably filled with a secondary sealant. The secondary sealant contributes to the mechanical stability of the insulating glazing unit and absorbs part of the climatic loads that act on the edge seal.

Preferably, the secondary sealant contains polymers or silane-modified polymers, particularly preferably organic polysulfides, silicones, room-temperature vulcanizing (RTV) silicone rubber, peroxide vulcanizing silicone rubber, and/or addition vulcanizing silicone rubber, polyurethanes, and/or butyl rubber. These sealants have a particularly good stabilizing effect.

In a preferred embodiment of the insulating glazing unit according to the invention, the connection region of the connector is enlarged such that it protrudes somewhat relative to the plug-in legs. The distance of protrusion U of the outer surface of the connection region beyond the outer sides of the plug-in legs is 1 mm to 10 mm, preferably 2 mm to 5 mm, and particularly preferably 3 mm to 4 mm. Preferably, the distance of protrusion U is selected such that after the filling of the outer interpane space with a secondary sealant, the outer surface of the connection region and the secondary sealant end flush. In this embodiment, the outer surface of the connection region is not touched by the secondary sealant. Thus, the risk of contamination of the membrane is reduced.

The hollow space preferably contains a desiccant, preferably silica gels, molecular sieves, CaCl₂, Na₂SO₄, activated carbon, silicates, bentonites, zeolites, and/or mixtures thereof.

In a preferred embodiment of the insulating glazing unit, the insulating glazing unit includes a connector according to the invention, as described above.

The first and second pane of the insulating glazing unit preferably contain glass and/or polymers, preferably flat glass, float glass, quartz glass, borosilicate glass, soda lime glass, polymethylmethacrylate, and/or mixtures thereof. In an alternative embodiment, the first pane and/or the second pane can be implemented as a composite glass pane.

The insulating glazing unit can also include more than two panes.

The invention further includes a method for producing an insulating glazing unit, in particular an insulating glazing unit according to the invention, wherein, first, at least one hollow-profile strip is prepared and its ends are connected to at least one connector according to the invention to form a complete spacer frame. In the case of a discontinuous hollow-profile strip, the individual sections can be connected with prior art corner connectors without an integrated membrane. At least one section of the hollow-profile strip is filled with a desiccant. Then, the first and second pane are installed on the spacer frame via a primary sealant, creating an inner interpane space and an outer interpane space. In the last step, a secondary sealant is installed in the outer interpane space, and the pane arrangement is pressed. The method according to the invention for producing an insulating glazing unit with a membrane is significantly simplified compared to prior art methods for after-the-fact installation of pressure equalization elements in a hollow-profile spacer. No separate step is necessary for installation of a membrane. Also, no bored holes have to be made since the cavity with the membrane is already integrated into the connector and this connector now only has to be inserted into the hollow-profile strips.

The invention further includes the use of the insulating glazing unit according to the invention as a building interior glazing unit, a building exterior glazing unit, and/or a façade glazing unit.

The invention is explained in detail in the following with reference to figures. The figures are purely schematic representations and not true to scale. They in no way restrict the invention. They depict:

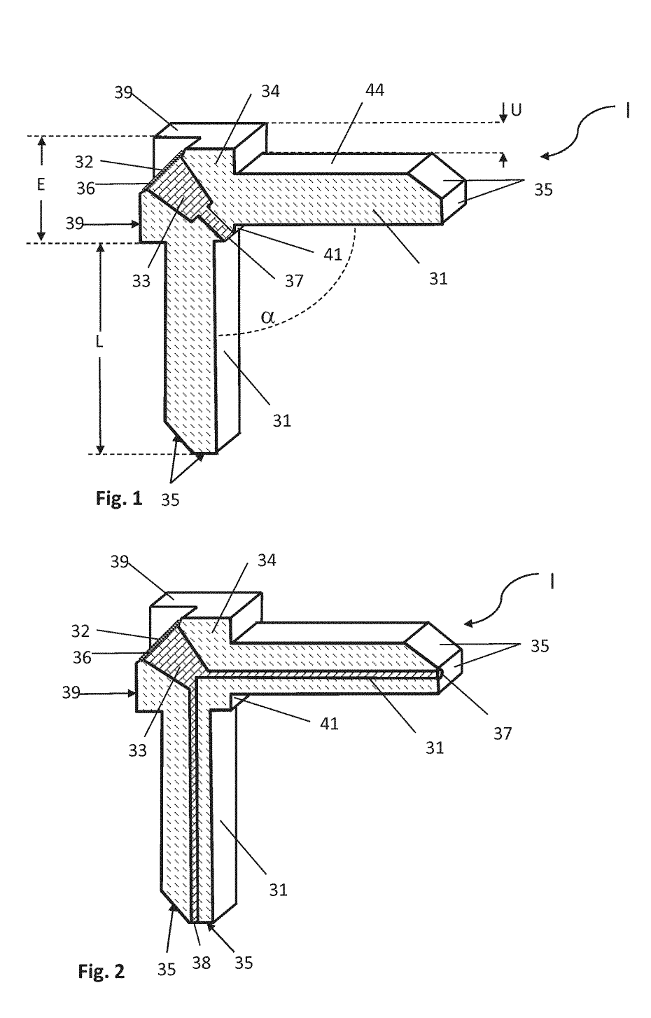

FIG. 1a schematic, perspective cross-section of an embodiment of a corner connector according to the invention,

FIG. 2 a schematic, perspective cross-section another embodiment of a corner connector according to the invention,

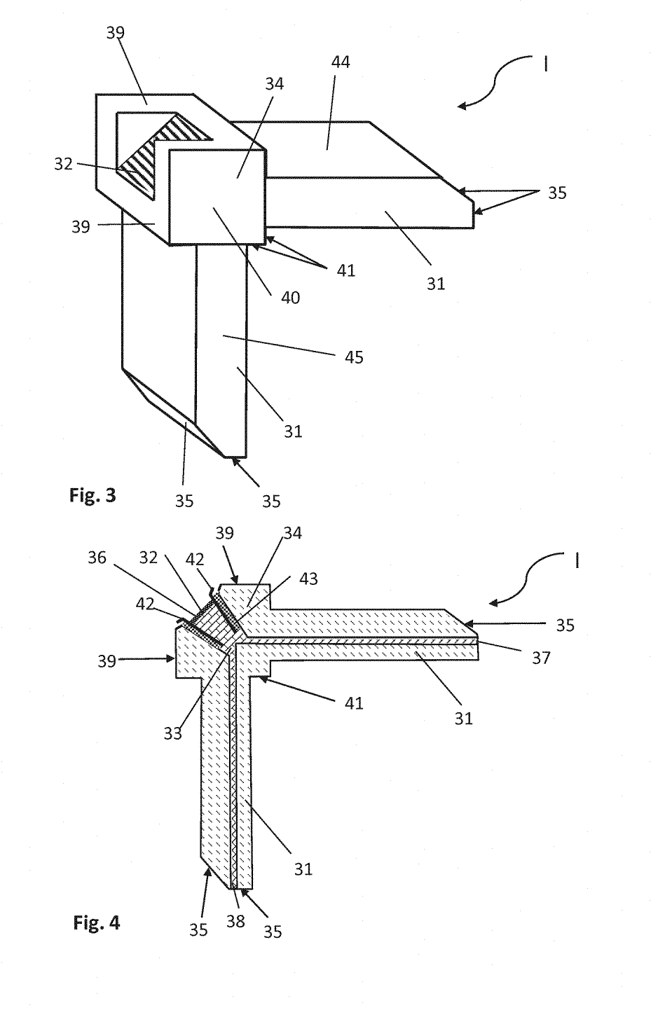

FIG. 3 a schematic outside view of the embodiment of a corner connector according to the invention depicted in FIGS. 1 and 2,

FIG. 4 a schematic cross-section of another embodiment of a corner connector according to the invention,

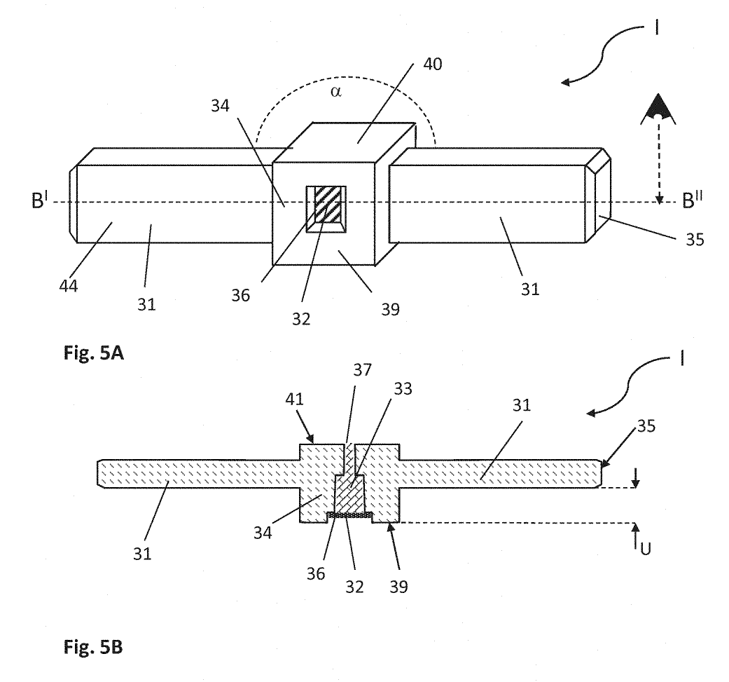

FIG. 5A a schematic outside view of an embodiment of a longitudinal connector according to the invention,

FIG. 5B, respectively, a schematic cross-section along the line B^{I}-B^{II} of the longitudinal connector depicted in FIG. 5A,

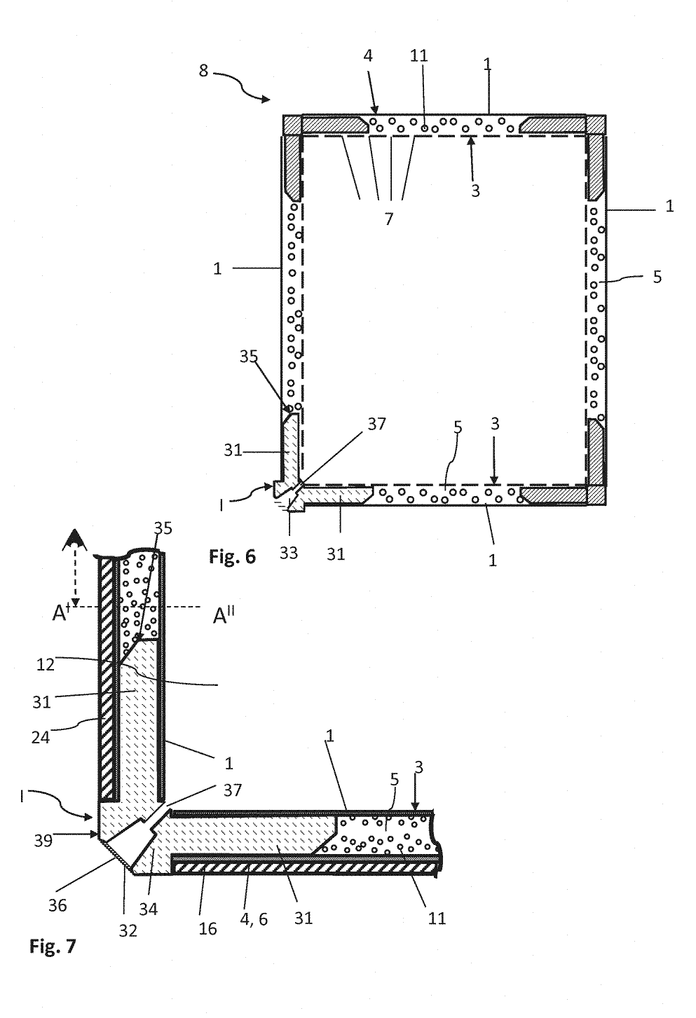

FIG. 6 a cross-section of a spacer frame with the corner connector according to the invention depicted in FIG. 1,

FIG. 7 the corner region of an insulating glazing unit according to the invention in cross-section,

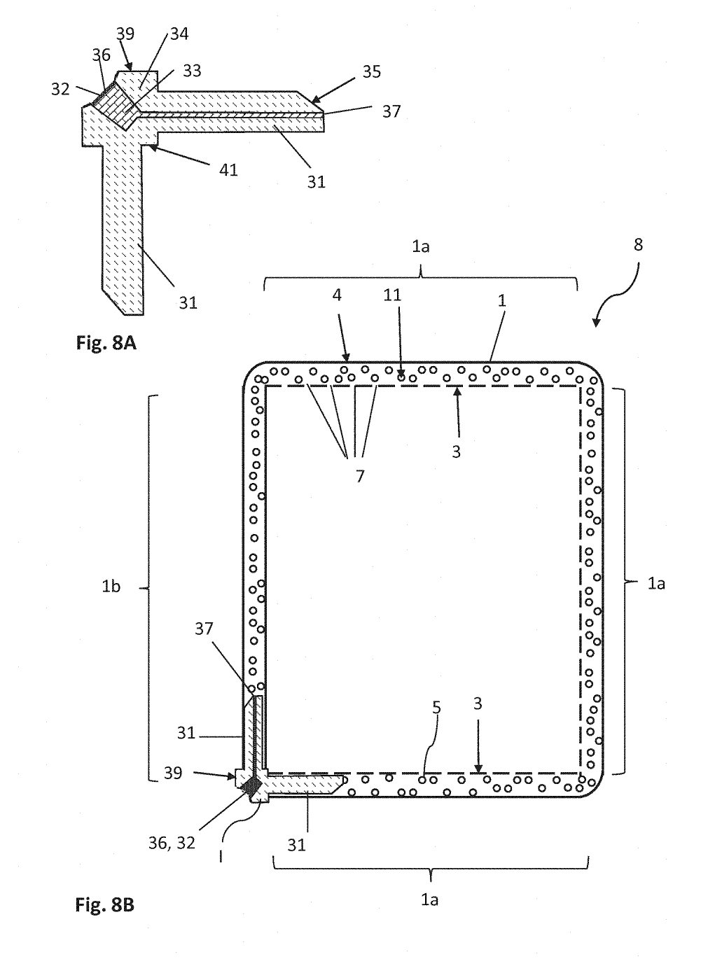

FIG. 8A a schematic cross-section of another embodiment of a corner connector according to the invention,

FIG. 8B a cross-section of a spacer frame with the corner connector according to the invention depicted in FIG. 8A,

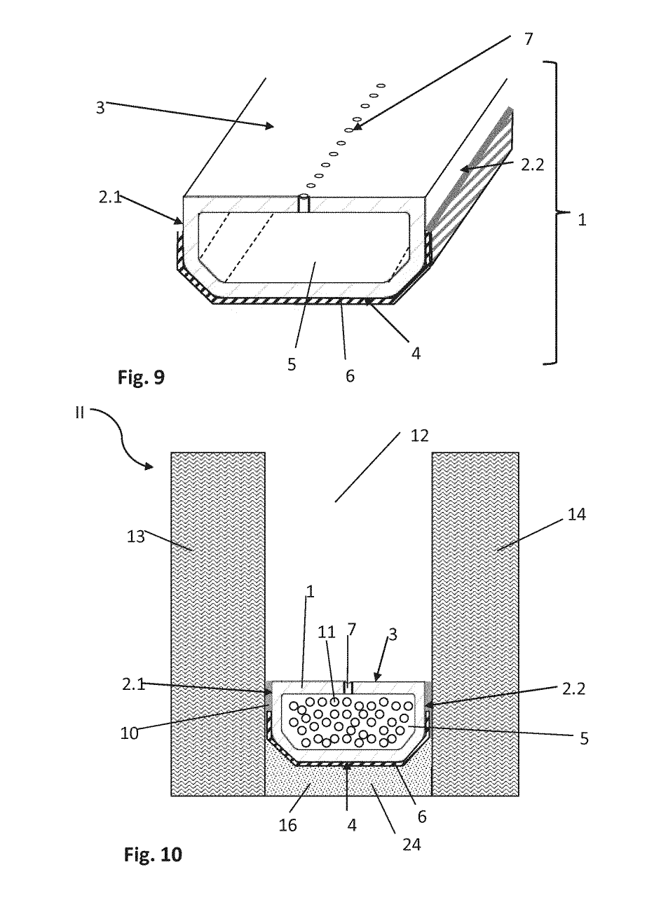

FIG. 9 a schematic cross-section of a hollow profile usable in an insulating glazing unit according to the invention,

FIG. 10 a cross-section along the line A^{I}-A^{II} depicted in FIG. 7 of an insulating glazing unit according to the invention.

FIG. 1 depicts a connector according to the invention in the form of a corner connector. The representation is greatly simplified. Fins or retaining elements, as they are used according to the prior art, to fix the corner connectors in a hollow-profile strip, are, for example, not shown. These can be added by the person skilled in the art as needed. The connector I comprises two plug-in legs 31, which are connected to one another in the connection region 34. The two plug-in legs 31 form an angle α (alpha) of 90°. The connection region 34 has an outer surface 39 that points, in the finished insulating glazing unit II, toward the surroundings and an inner surface 41 that points, in the finished insulating glazing unit, toward the inner interpane space 12. A cavity 33 is integrated in the connection region 34. The cavity 33 has a first opening 36, which is made in the region of the outer surface 39. The first opening 36 is closed with a gas-permeable and water-vapor-tight membrane 32. The second opening 37 is arranged in the inner surface 41 such that, in the finished insulating glazing unit II, a direct passage from the inner interpane space 12 to the outer surroundings is created. Thus, pressure equalization is enabled in the inner interpane space 12 directly by aeration. The water-vapor-tight membrane 32 prevents penetration of moisture into the inner interpane space 12. The plug-in legs 31 and the connection region 34 are produced from a polyamide in one piece in an injection molding process. The membrane 32 made of expanded PTFE is already integrated during the injection molding process and is thus stably affixed. The connection region 34 protrudes relative to the plug-in legs 31. The distance of protrusion U of the outer surface 39 beyond the outer side 44 of the plug-in legs 31 is 3.5 mm. The connection region 34 also protrudes somewhat relative to the side faces of the plug-in legs (not discernible in the figure). The size of this distance of protrusion depends on the hollow-profile strip 1 to be used. Preferably, in the insulating glazing unit, the hollow-profile strip 1 ends flush with the pane contact surfaces 40 of the connection region 34. The membrane 32 is mounted in the connection region 34 in a recess such that it is protected against mechanical damage (see also FIG. 3). The protruding connection region 34 has, additionally, the advantage that by this means, reinforcement of the connection region 34 is achieved, which contributes to an increase in the stability of the connector I. The connection region 34 is implemented rigid, in other words, the angle α (alpha) cannot be substantially changed. The membrane 32 is thus additionally stabilized since movements in the region of the membrane 32 are avoided. The precise dimensions of the corner connector depend on the hollow-profile strips 1 used. The length L of a plug-in leg is, in the example, 3.2 cm, and the length E of the connection region approx. 1.2 cm.

FIG. 2 depicts another connector I according to the invention in the form of a corner connector. The connector I differs from that depicted in FIG. 1 in the design of the cavity 33. The cavity 33 has three openings 36, 37, and 38. The first opening 36 is arranged, as described with regard to FIG. 1, in the outer surface 39 and is closed with a membrane 32. The second opening 37 and the third opening 38 are situated in the end faces 35 of the two plug-in legs 31. This embodiment enables simultaneous aeration in two sections of a hollow-profile strip 1 such that particularly efficient pressure equalization can be achieved.

FIG. 3 depicts an outside view toward the connectors depicted in FIGS. 1 and 2. Here, the membrane 32 has a rectangular shape. The membrane can have any shape adapted to the respective first opening 36 of the cavity 33. The membrane 32 is mounted in a recess in the connection region 34 and is thus well protected against damage during assembly of the glazing unit. The connection region 34 also has two pane contact surfaces 40. The pane contact surfaces 40 are the surfaces of the connection region 34 that point, in the finished insulating glazing unit II, toward the outer panes, run parallel to the outer panes of the insulating glazing unit and are, optionally, connected thereto. The pane contact surfaces 40 protrude somewhat such that after insertion of the hollow-profile strips 1, an end flush with the side walls of the hollow-profile strip is possible. This simplifies the assembly of the insulating glazing unit II.

FIG. 4 depicts a cross-section of another embodiment of a connector I according to the invention. The connector I differs from the connector shown in FIG. 2 in the type of attachment of the membrane 32 in the cavity 33. Here, the membrane 32 is arranged in a sleeve 42 and attached via a seal 43 in the first opening 36 of the cavity 33. The sleeve 42 is made of aluminum and is sealingly mounted via a butyl sealant in the cavity 33. The air flowing in can thus arrive in the inner interpane space in the finished insulating glazing unit only via the membrane 32. An advantage of the after-the-fact insulation of the membrane 32 using a sleeve 42 is the increased flexibility of the design. The injection molded connector I can be provided, as needed, with a pressure equalization membrane or, alternatively, even with a pressure equalization valve that is adapted to the respective insulating glazing unit and the pressure equalization required.

FIG. 5A depicts a schematic outside view of an embodiment of a connector I iaccording to the invention in the form of a longitudinal connector. FIG. 5B depicts a cross-section of the longitudinal connector along the line B^{I}-B^{II}. The viewing direction is indicated by an arrow in FIG. 5A. The representation of the connector is greatly simplified. Fins or retaining elements, as are used according to the prior art, to fix the longitudinal connector in a hollow-profile strip, are, for example, not shown. These can be added by the person skilled in the art as needed. The longitudinal connector I comprises two plug-in legs 31, which are connected via a connection region 34. The plug-in legs 31 form an angle α (alpha) of 180°. The connection region 34 protrudes relative to the plug-in legs 31. The distance of protrusion U of the outer surface 39 of the connection region 34 beyond the outer side 44 of the plug-in legs 31 is 4 mm. The enlargement of the connection region 34, in particular in the direction of the outer surface 39, has the advantage that the membrane 32 can be installed in a recess of the connection region 34. Thus, the membrane 32 is better protected against damage. The gas-and water-vapor-tight membrane 32 closes the first opening 36 of the cavity 33. The second opening 37 of the cavity 33 is arranged in the inner surface 41 of the connection region. Thus, in the finished insulating glazing unit II, pressure equalization is enabled directly between the inner interpane space 12 and the surroundings.

FIG. 6 depicts a cross-section through a spacer frame 8 with a connector I according to the invention. The spacer frame 8 comprises four hollow-profile strips 1, which are in each case connected in the corners by corner connectors to form a complete spacer frame 8. The individual strips along the longer sides of the spacer are 200 cm long, while the strips along the shorter sides are, in each case, 100 cm long. The four strips are connected via three prior art corner connectors and one corner connector I according to the invention and form a rectangular spacer frame 8. The corner connector I according to the invention is described precisely in FIG. 1. The two plug-in legs 31 of the corner connector I according to the invention are inserted into two hollow-profile strips 1 and connected via via a connection region 34. The connection region 34 is exposed and is not plugged into the hollow-profile strip 1. The end faces 35 of the plug-in legs 31 point toward the hollow space 5 and do not rest against an inner side of the hollow-profile strip 1. The structure of a hollow-profile strip 1 is shown, by way of example, in FIG. 9. The hollow-profile strip 1 contains a hollow space 5. The hollow space 5 is filled with a desiccant 11, for example, with molecular sieve. The glazing interior wall 3 is implemented permeable along all hollow-profile strips 1. The hollow space 5 makes connection, in the finished insulating glazing unit, via perforations 7 in the glazing interior wall 3 of the hollow-profile strip 1 with the inner interpane space 12. The desiccant 11 can thus absorb moisture out of the inner interpane space 12 and can prevent fogging of the panes. Since all hollow-profile strips 1 are filled with molecular sieve, the absorption capacity for moisture is maximal, ensuring adequate drying of the inner interpane space 12 over the entire service life of the insulating glazing unit. The corner connector I according to the invention includes a cavity 33, which has a first opening 36 in the outer surface 39 of the connection region 34 and a second opening 37 in the inner surface 41. In the finished insulating glazing unit I, the second opening 37 is open toward the inner interpane space 12 and the first opening 36 is open toward the surroundings (see FIG. 7).

FIG. 7 depicts a corner region of an insulating glazing unit II according to the invention in cross-section. The connector I is the connector according to the invention depicted in FIG. 1. The two plug-in legs 31 are , in each case, arranged in a hollow space 5 of a hollow-profile strip 1. The cavity 33 connects the inner interpane space 12 with the surroundings. The cavity 33 has a first opening 36 in the outer surface 39 of the connection region and a second opening in the inner surface 41, which points toward the inner interpane space. A gas-permeable and water-vapor-tight membrane 32 over the first opening 36 prevents the penetration of moisture into the inner interpane space 12. The glazing interior wall 3 of the hollow-profile strip 1 is implemented gas-permeable, for example, made from a porous plastic, such that a gas exchange can occur between an inner interpane space 12 and hollow space 5. Thus, moisture can be absorbed out of the inner interpane space 12 by the molecular sieve 11 contained in the hollow space 5. When a gas-permeable material is used for the hollow-profile strip 1, the outer wall 4 is provided with a barrier film 6, which seals the edge seal. The barrier film 6 is a multilayer film. Adjacent the outer wall 4 and the corner connector I, a secondary sealant 16, for example, an organic polysulfide, is arranged in the outer interpane space 24, which improves the mechanical stability of the insulating glazing unit II. The material of the secondary sealant 16 ends flush with the outer surface 39 of the connection region 34. Thus, during the production of the insulating glazing unit II, contamination of the membrane 32 by secondary sealant 16 is prevented.

FIG. 8A depicts a cross-section of a connector according to the invention in the form of a corner connector I. It differs from that depicted in FIG. 2 in that the cavity 33 is arranged only along one of the two plug-in legs 31. Accordingly, the cavity 33 has only a first opening 36 in the outer surface 39 and a second opening 37 in the end face 35 of a plug-in leg 31. Thus, aeration can be done selectively in a specific section of the spacer frame 8.

FIG. 8B depicts a cross-section of a spacer frame 8 according to the invention with the corner connector I described in FIG. 8A. The spacer frame 8 comprises a hollow-profile strip 1 and a corner connector I according to the invention. The hollow-profile strip 1 is bent to form a rectangular frame. The two ends of the hollow-profile strip 1 are connected via the corner connector I according to the invention. The hollow-profile strip 1 has a glazing interior wall 3, which, in the finished insulating glazing unit, points toward the inner interpane space 12. The glazing interior wall 3 comprises permeable sections 1a and one impermeable section 1b. In the permeable section 1a, perforations 7 are made in the glazing interior wall 3 such that, in the finished insulating glazing unit, a gas exchange can occur between the inner interpane space 12 and the hollow space 5 of the hollow-profile strip 1. The plug-in leg 31 of the connector I according to the invention with the second opening 37 engages in the impermeable section 1b, and the other plug-in leg 31 engages in a permeable section 1a. The hollow space 5 of the hollow profile 1 is filled along the entire perimeter of the spacer frame 8 with a desiccant. The connection region 34 of the corner connector I according to the invention is, with the exception of the cavity 33, implemented solid, in other words, it separates the sections 1a and 1b connected by the corner connector I from one another and prevents a gas exchange between these two sections. In the finished insulating glazing unit, the ambient air flows out of the second opening 37 into the hollow space 5 of the impermeable section 1b and is pre-dried there through contact with the desiccant 11. The air cannot enter the inner interpane space 12 via the perforations 7 in the glazing interior wall 3 until it reaches the region of the the following section 1a, which is connected to the impermeable section 1b. Thus, efficient drying of the ambient air is achieved.

FIG. 9 depicts a perspective cross-section of a hollow-profile strip 1. The hollow-profile strip 1 comprises two parallel side walls 2.1 and 2.2, which establish the contact with the panes 13 and 14 of an insulating glazing unit II. The side walls 2.1 and 2.2 are connected via an outer wall 4 and a glazing interior wall 3. The outer wall 4 runs substantially parallel to the glazing interior wall 3. The hollow-profile strip 1 is made of a polymer and, additionally, glass-fiber-reinforced and contains, for example, styrene acrylonitrile (SAN) and approx. 35 wt.-% glass-fiber. The hollow-profile strip 1 has a hollow space 5 and the wall thickness of the polymeric hollow-profile 1 is, for example, 1 mm. A barrier film 6, which comprises at least one metal-containing barrier layer and one polymeric layer, is mounted on the outer wall 4. The entire hollow-profile strip has thermal conductivity less than 10 W/(m K) and gas permeation less than 0.001 g/(m² h).

FIG. 10 depicts a cross-section of a detail of an insulating glazing unit according to the invention along the line A^{I}-A^{II} in FIG. 7 (viewing direction is indicated in FIG. 7). The insulating glazing unit II includes the hollow-profile strip 1 described in FIG. 9. The glass-fiber-reinforced polymeric hollow-profile strip 1 with the barrier film 6 attached thereon is arranged between a first pane 13 and a second pane 14. The barrier film 6 is arranged on the outer wall 4 and on a portion of the side walls 2.1 and 2.2. The first pane 13, the second pane 14, and the barrier film 6 delimit the outer interpane space 24 of the insulating glazing unit. The secondary sealant 16, which contains, for example, polysulfide, is arranged in the outer interpane space 24. The barrier film 6 insulates, along with the secondary sealant 16, the inner interpane space 12 and reduces the thermal transfer from the glass-fiber-reinforced polymeric hollow-profile strip 1 into the inner interpane space 12. The barrier film 6 can, for example, be attached on the hollow-profile strip 1 with a polyurethane (PUR) hotmelt adhesive. A primary sealant 10 is preferably arranged between the side walls 2.1, 2.2 and the panes 13, 14. This contains, for example, a butyl. The primary sealant 10 overlaps the barrier film 6 in order to prevent possible interfacial diffusion. The first pane 13 and the second pane 14 preferably have the same dimensions and thicknesses. The panes preferably have optical transparency of >85%. The panes 13,14 contain, for example, quartz glass. Inside the hollow-profile strip 1, a desiccant 11, for example, molecular sieve, is arranged inside the hollow space 5. This desiccant 11 can be filled into the hollow space 5 of the hollow-profile strip 1 before the assembly of the insulating glazing unit. The glazing interior wall 3 includes relatively small perforations 7 or pores, which enable a gas exchange with the inner interpane space 12.

### LIST OF REFERENCE CHARACTERS

I connector
II insulating glazing unit
1 hollow-profile strip
2.1 first side wall
2.2 second side wall
3 glazing interior wall
4 outer wall
5 hollow space
6 barrier film
7 perforations in the glazing interior surface
8 spacer frame
10 primary sealant
11 desiccant
12 inner interpane space
13 first pane
14 second pane
16 secondary sealant
24 outer interpane space
31 plug-in leg
32 membrane
33 cavity
34 connection region
35 end face of a plug-in leg
36 first opening of the cavity
37 second opening of the cavity
38 third opening of the cavity
39 outer surface of the connection region
40 pane contact surface of the connection region
41 inner surface of the connection region
42 sleeve
43 seal
44 outer side of a plug-in leg
45 side surface of a plug-in leg
L length of a plug-in leg
E length of the connection region
U distance of protrusion of the outer surface of the connection region beyond the outer side of a plug-in leg

1.-15. (canceled)

16. A connector, comprising:
two plug-in legs adapted for insertion into a hollow-profile strip; and
a connection region connecting the two plug-in legs, the connection region including
i) an outer surface;
ii) two pane contact surfaces; and
iii) an inner surface,
wherein
the connector is adapted to connect two hollow-profile strips of an insulating glazing unit,
the connector comprises a cavity adapted for establishing a passage from an inner interpane space to corresponding surroundings,
the cavity comprises a first opening in the outer surface of the connection region, and
the first opening is sealed with a gas-permeable and water-vapor-tight membrane.

17. The connector according to claim 16, wherein the gas-permeable and water-vapor-tight membrane comprises polytetrafluoroethylene (PTFE).

18. The connector according to claim 17, wherein the polytetrafluoroethylene (PTFE) is an expanded microporous polytetrafluoroethylene.

19. The connector according to claim 16, wherein the connector is a corner connector or a longitudinal connector.

20. The connector according to claim 16, wherein the cavity comprises a second opening in the inner surface of the connection region.

21. The connector according to claim 16, wherein:
the cavity is arranged along a plug-in leg of the two plug-in legs, and
a second opening of the cavity is arranged in an end face of said plug-in leg.

22. The connector according to claim 16, wherein:
the cavity is arranged along both plug-in legs, and
a second opening and a third opening of the cavity are arranged in respective end faces of the two plug-in legs.

23. The connector according to claim 16, wherein at least the outer surface of the connection region is provided with a water-vapor-tight barrier.

24. The connector according to claim 23, wherein the outer surface of the connection region is coated with a metal layer.

25. An insulating glazing unit, comprising:
I) a first pane;
II) a second pane;
III) a peripheral spacer frame arranged between the first and second panes, the peripheral spacer frame comprising at least one hollow-profile strip and at least one connector; and
IV) an inner interpane space delimited by the peripheral spacer frame and the first and second panes,
wherein the connector comprises:
a) two plug-in legs inserted into ends of the at least one hollow-profile strip;
b) a connection region connecting the two plug-in legs,
wherein the connection region comprises:
b1) an outer surface pointed toward surroundings of the inner interpane space;
b2) two pane contact surfaces; and
b3) an inner surface pointed toward the inner interpane space; and
c) a cavity adapted for establishing a passage from the inner interpane space to the surroundings,
wherein the cavity comprises a first opening in the outer surface of the connection region, and
wherein the first opening is sealed with a gas-permeable and water-vapor-tight membrane.

26. The insulating glazing unit according to claim 25, wherein the cavity comprises a second opening in the inner surface.

27. The insulating glazing unit according to claim 26, wherein the at least one hollow-profile strip comprises:
a first side wall;
a second side wall arranged parallel to the first side wall;
a glazing interior wall arranged perpendicular to the first and second side walls, the glazing interior wall connecting the first side wall to the second side wall;
an outer wall arranged substantially parallel to the glazing interior wall, the outer wall connecting the first side wall to the second side wall; and
a hollow space that is surrounded by the side walls, the glazing interior wall, and the outer wall,
wherein
the glazing interior wall comprises at least one permeable section adapted to provide gas exchange and moisture exchange between the inner interpane space and the hollow space, and
the hollow space comprises a desiccant in the at least one permeable section.

28. The insulating glazing unit according to claim 27, wherein:
the cavity is arranged along a plug-in leg of the two plug-in legs,
a second opening of the cavity is arranged in an end face of said plug-in leg, and
the second opening is arranged in a section of the hollow-profile strip whose hollow space is one of: a) connected to the permeable section, and b) is a permeable section.

29. The insulating glazing unit according to claim 28, wherein:
the second opening is arranged in an impermeable section of the hollow-profile strip having an impermeable glazing interior wall, and
the impermeable section is connected to a permeable section.

30. A method for producing an insulating glazing unit, the method comprising the steps of:
I) preparing at least one hollow-profile strip;
II) connecting ends of the at least one hollow-profile strip to form a complete spacer frame using at least one connector;
Ill) filling the hollow-profile strip with a desiccant;
IV) installing a first pane and a second pane on the spacer frame via a primary sealant, thereby creating an inner interpane space and an outer interpane space;
V) installing a secondary sealant in the outer interpane space; and
VI) pressing the pane arrangement,
wherein the at least one connector comprises:
a) two plug-in legs adapted for insertion into the hollow-profile strip,
b) a connection region connecting the two plug-in legs, wherein the connection region comprises
b1) an outer surface,
b2) two pane contact surfaces, and
b3) an inner surface,
c) a cavity adapted for establishing a passage from an inner interpane space to corresponding surroundings,
wherein the cavity comprises a first opening in the outer surface of the connection region, and
wherein the first opening is sealed with a gas-permeable and water-vapor-tight membrane.

31. A method, comprising using of the insulating glazing unit according to claim 16 as one or more of: a) a building interior glazing unit, b) a building exterior glazing unit, and c) a façade glazing unit.
